(19) United States
(12) Patent Application Publication
(10) Pub. No.: US 2021/0021416 A1
(43) Pub. Date: Jan. 21, 2021

(54) SYSTEMS AND METHODS FOR USING AUTOMATED BROWSING TO RECOVER SECURED KEY FROM A SINGLE DATA ENTRY

(71) Applicant: Capital One Services, LLC, McLean, VA (US)

(72) Inventors: Leonardo COLMENARES, Richmond, VA (US); Dennis Gregory GIBSON, Powhatan, VA (US)

(73) Assignee: Capital One Services, LLC, McLean, VA (US)

(21) Appl. No.: 16/517,290

(22) Filed: Jul. 19, 2019

(51) Int. Cl. H04L 9/08; G06F 16/9532; H04L 29/06; G06F 16/904; G06F 9/451; G06F 9/54; H04L 9/32

(52) U.S. Cl. CPC H04L 9/0894; G06F 16/9532; H04L 63/0815; H04L 9/3226; G06F 9/451; G06F 9/547; G06F 16/904

(57) ABSTRACT

Disclosed are systems and methods for using automated browsing to retrieve a protected key based on a single input data entry. For example, a method may include receiving an input at a first user interface, creating a headless browser that configures the a processor to automatically browse web pages without loading any graphical user interface, identifying credential data input fields on a first set of web pages, identifying a corresponding authentication credential for each of the one or more credential data input fields, automatically entering the identified corresponding authentication credentials into the credential data input fields in the first set of web pages, determining a unique identifier, based on the input from the first user interface, entering a web interface based on the unique identifier, retrieving a secured key from the web interface, and outputting the secured key at the first user interface.

### TECHNICAL FIELD

Various embodiments of the present disclosure generally relate to retrieving protected data based on a user input, and more particularly, to automatically retrieving and returning a protected key stored in a database using a single data entry provided by a user at a user interface.

### BACKGROUND

Device management systems are often utilized by system administrators (e.g., a technical support service specialist or help desk staff) as a useful tool for providing support for computing devices. For example, a device management system may store and maintain secure records (e.g., digital keys, passwords, etc.) associated with each of the user computing devices being used and supported within an enterprise, so that the system administrators may retrieve the records from it as needed for repairs, maintenance, updates, etc. However, for retrieving such a record manually, a system administrator may have to iterate through labor-intensive and potentially unsecure steps (e.g., logging in and manually navigating through interfaces of the device management system) every time a secure record is needed. On the other hand, to retrieve such a secure record automatically, an administrator may have to depend on a third party application or third party application programming interface (API) (e.g., a specific API generated by a provider of the device management system), in order to be granted automated access to data stored in a device management system. Having to depend on a third party application or a third party API may, for example, reduce the level of security, efficiency, and/or reliability of access for system administrators. Thus, it is highly desirable for administrator systems (e.g., computing devices used by system administrators) to be able to automatically access and safely retrieve secure records from protected, external sources such as a device management system, without having to depend on third party applications or APIs.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed to use automated browsing for retrieving a protected key based on a single input data entry.

In one embodiment, a computer system is disclosed for using automated browsing to retrieve a protected key based on a single input data entry. The computer system may comprise: a memory having processor-readable instructions stored therein; and at least one processor configured to access the memory and execute the processor-readable instructions, which when executed by the processor configures the processor to perform a plurality of functions, including functions for: receiving a user input at a first user interface; creating a headless browser that configures the at least one processor to automatically browse web pages without loading any graphical user interface; identifying, using the headless browser, one or more credential data input fields on a first set of one or more web pages; identifying a corresponding authentication credential for each of the one or more credential data input fields in the first set of the one or more web pages; automatically entering the identified corresponding authentication credential into each of the one or more credential data input fields in the first set of the one or more web pages; determining a unique identifier, based on the user input received at the first user interface; entering, using the headless browser, a web interface based on the unique identifier; retrieving, using the headless browser, a secured key from the web interface; and outputting the secured key at the first user interface.

In accordance with another embodiment, a computer-implemented method is disclosed for using automated browsing to retrieve a protected key based on a single input data entry. The computer-implemented method may comprise: receiving, by one or more processors, a user input at a first user interface; creating, by the one or more processors, a headless browser that configures the one or more processors to automatically browse web pages without loading any graphical user interface; identifying, by the one or more processors, using the headless browser, one or more credential data input fields on a first set of one or more web pages; identifying, by the one or more processors, a corresponding authentication credential for each of the one or more credential data input fields in the first set of the one or more web pages; automatically entering, by the one or more processors, the identified corresponding authentication credential into each of the one or more credential data input fields in the first set of the one or more web pages; determining, by the one or more processors, a unique identifier, based on the user input received at the first user interface; entering, by the one or more processors, using the headless browser, a web interface based on the unique identifier; retrieving, by the one or more processors, using the headless browser, a secured key from the web interface; and outputting, by the one or more processors, the secured key at the first user interface.

In accordance with another embodiment, a computer-implemented method is disclosed for using automated browsing to retrieve a recovery key based on a single input data entry. The computer-implemented method may comprise: receiving, by one or more processors, a user input at a first user interface, wherein the first interface is in communication with an Application Programming Interface (API) gateway; creating, by the one or more processors, a headless browser that configures the one or more processors to automatically browse web pages without loading any graphical user interface; identifying, by the one or more processors, using the headless browser, one or more credential data input fields on a first set of one or more web pages; identifying, by the one or more processors, a corresponding authentication credential for each of the one or more credential data input fields in the first set of the one or more web pages; automatically entering, by the one or more processors, the identified corresponding authentication credential into each of the one or more credential data input fields in the first set of the one or more web pages; accepting the user input at the API gateway; determining, by the one or more processors, a unique identifier, based on the user input accepted at the API gateway; entering, by the one or more processors, using the headless browser, a web interface based on the unique identifier; retrieving, by the one or more processors, using the headless browser, a recovery key from the web interface, wherein the recovery key is configured to recover data protected using a disk encryption program installed in a first operating system of a first computing device; and outputting, by the one or more processors, the recovery key at the first user interface.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a diagram of an exemplary environment in which methods, systems, and other aspects of the present disclosure may be implemented.

FIGS. 2A-2C depict simplified screen shots of an exemplary user interface at which a user input may be received and a secured key may be returned to the user in response to the user input, according to one or more embodiments.

FIG. 3 depicts a flowchart of an exemplary method for using automated browsing to retrieve a protected key based on a single input data entry, according to one or more embodiments.

FIG. 4 depicts an exemplary computer device or system, in which embodiments of the present disclosure, or portions thereof, may be implemented.

### DETAILED DESCRIPTION OF EMBODIMENTS

The following embodiments describe systems and methods for automatically retrieving and returning a protected key stored in a secured database, using a single data entry provided by a user at a user interface. Such a retrieval may be performed using automated browsing techniques, by which one or more processors may be configured to access and retrieve secure records from protected, external sources such as a device management system, (i) in a uniquely automated process, and (ii) without having to depend on third party applications or APIs. Specifically, automated browsing may be performed by first creating a headless browser that configures one or more processors to automatically browse web pages without loading any graphical user interface. Next, the one or more processors may utilize the created instance of the headless browser to recognize one or more authentication credential input fields on one or more authentication web pages associated with a device management system, and to log into the device management system using predetermined authentication credentials of a system administrator. After logging into the device management system, the one or more processors may then determine a unique identifier (e.g., an identifier of a user computing device) based on the user input initially entered at the user interface, and use the headless browser to enter an interface specifically based on (e.g., corresponding to) the unique identifier. From this interface, the one or more processors may retrieve a secured key associated with the unique identifier.

In this way, a specifically customized use of a headless browser practically applied to a uniquely automated process of retrieving protected data from a secure data source is an unconventional automation technique, which necessarily achieves functional improvements in computer-implemented data recovery technology (e.g., through the specific process described in more detail below), in a sharp contrast to merely providing a well-known or routine environment for performing a manual task. For example, overall system bottleneck and traffic associated with a server system may be reduced, as a result of usage of optimal, quick, and efficient automated processes employed by system administrators' devices.

The subject matter of the present description will now be described more fully hereinafter with reference to the accompanying drawings, which form a part thereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter can be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

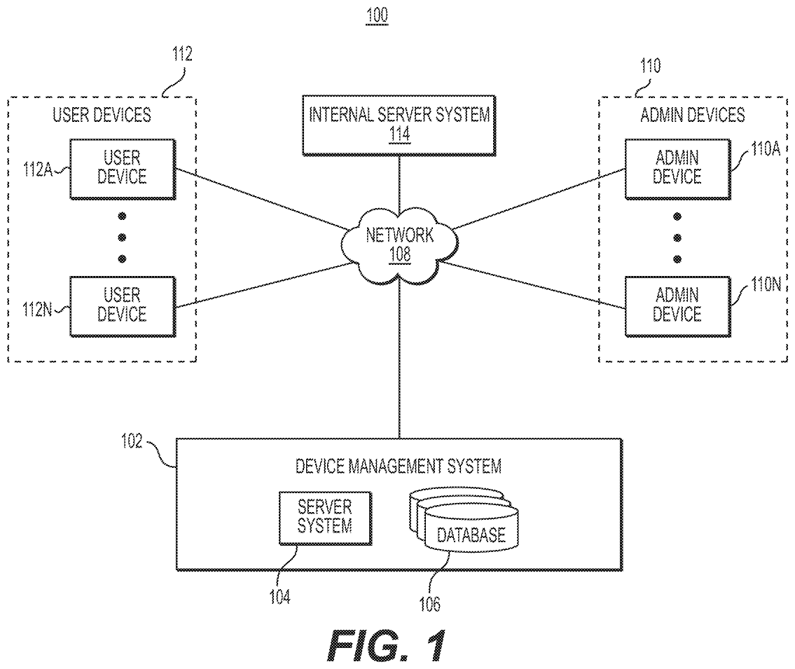

Referring now to the appended drawings, FIG. 1 shows a diagram of an exemplary environment 100, according to one or more embodiments of the present disclosure. As shown, the exemplary environment 100 may include a device management system 102, a network 108, admin devices 110, user devices 112, and internal server system 114. As used herein, a device management system 102 may be a term that collectively refers to a server system 104 and one or more databases 106 associated with the device management system 102, as depicted in FIG. 1. Admin devices 110 and user devices 112 may be computing devices, such as a computer, a mobile computing device, a tablet device, or the like.

In the exemplary environment 100, a device management system 102 (e.g., Jamf™ Pro, Microsoft™ System Center Configuration Manager, or any other unified technical support/management tool for supporting multiple computing devices) may be in communication with the network 108. The device management system 102, as noted above, may include server system 104 and one or more databases 106. In some implementations, the device management system 102 may facilitate system administrators (e.g., help desk or technical support staff for user devices 112) with supporting one or more user devices 112, by providing system administrators with device management service functions. The device management service functions may be accessed and utilized, by system administrators, via admin devices 110. The device management service functions may include, for example, troubleshooting, profile configuration, software installation and/or updates, user account management, running script(s), triggering of device management tasks, storing secured data for each device, monitoring performance, or any other tasks associated with technical support, in order to facilitate admin devices 110 with providing support on user devices 112.

The device management service functions at the device management system 102 may be accessed via admin devices 110 over the network 108. The network 108 may include, for example, one or more of a cellular network, a public land mobile network, a local area network, a wide area network, a metropolitan area network, a telephone network, a private network, an ad hoc network, an intranet, the Internet, a fiber optic based network, a cloud computing network, etc. The device management system 102 may allow access from computing devices, such as admin devices 110 and/or user devices 112, using one or more authentication-based access controls, which, for example, allows only authorized system administrators and/or authorized admin devices to access and/or receive the device management service functions. The one or more authentication-based access controls may include, for example, requiring users to enter one or more authentication credentials (e.g., user name, personal identification number, and/or password). The device management system 102 may grant and provide authentication credentials to authorized system administrators and/or admin devices 110, and may also store the authentication credentials for verifying authorized users or authorized devices when log-in attempts are detected by the server system 104.

The admin devices 110 may include one or more admin devices 110A-110N. The admin devices 110A-110N may be used by one or more system administrators of the exemplary environment 100, in order to support user devices 112. The user devices 112 may include one or more user devices 112A-112N, and the user devices 112A-112N may be used by one or more authorized users (e.g., authorized members of an enterprise that provide the user devices 112) of the exemplary environment 100. In some implementations, one or more of the admin devices 110 may also be used as one or more user devices 112, if the one or more admin devices 110 are configured to grant access to the users in addition to the system administrators. In some implementations, the one or more of the user devices 112 may also be used as one or more admin devices 110, if the one or more user devices 112 are configured to grant access to the system administrators in addition to the users.

The admin devices 110 may log into the device management system 102, when proper authentication credential(s) are entered by a system administrator at one or more of the admin devices 110. For example, an admin device 110A may be used to troubleshoot issues experienced by user device 112A. Once a system administrator successfully logs into the admin device 110A (e.g., by entering proper authentication credentials), the device management system 102 may provide the admin device 110A with one or more device management service functions, over the network 108, to facilitate with troubleshooting the issues of user devices 112A. The device management service functions may include, for example, storing and providing secured data (e.g., a recovery key configured to recover data protected using a disk encryption program installed in an operating system of user device 112A).

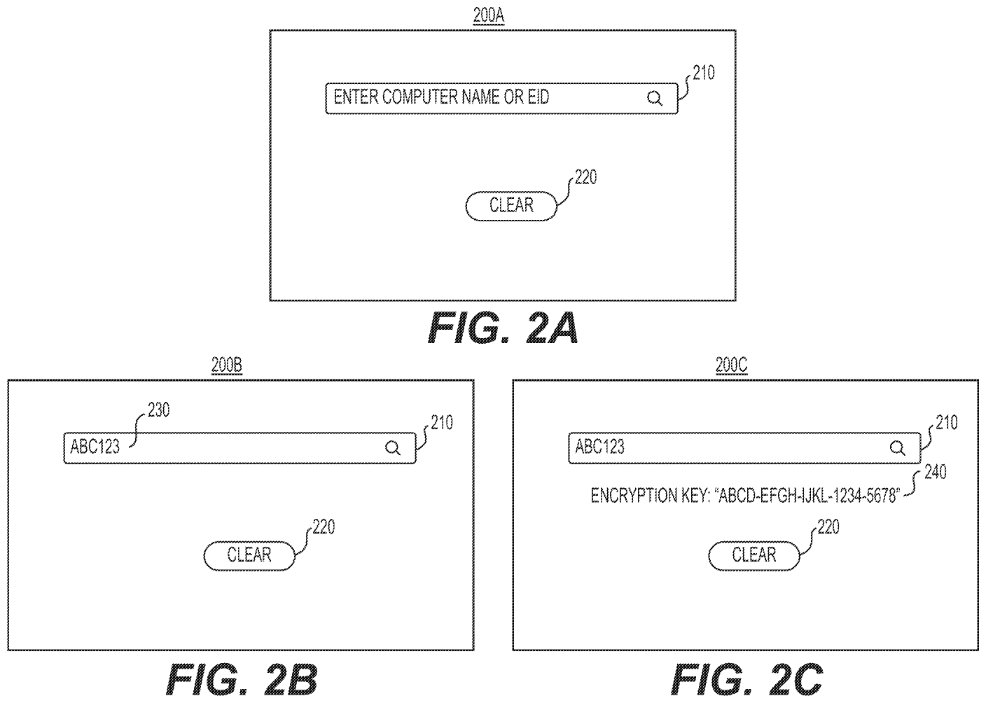

Internal server system 114 may also be in communication with the network 108. The internal server system 114 may comprise one or more processors and one or more databases, and may be configured to store and/or process a plurality of data, applications, user interfaces, application programming interfaces (APIs), microservices, and/or service components. The internal server system 114 may allow access from computing devices, such as admin devices 110 and/or user devices 112, using one or more access controls, which, for example, allows only authorized devices to communicate with data, applications, user interfaces, application programming interfaces (APIs), microservices, and/or service components that are provided by the internal server system 114. The one or more authentication-based access controls may include, for example, requiring users to enter one or more authentication credentials (e.g., user name, personal identification number, and/or password). The internal server system 114 may grant and provide authentication credentials to authorized users and/or authorized devices, and may also store the authentication credentials for verifying authorized users or authorized devices when log-in attempts are detected. The internal server system 114 may include an API endpoint, as well as an API gateway that is customized to perform a backend processing of user requests that involve browsing external systems, as discussed in more detail below with respect to FIG. 2B. In some implementations, the network 108 may include an intranet and/or a private network, and the internal server system 114 may communicate with admin devices 110 and/or user devices 112 via the intranet or the private network.

The number and arrangement of devices and networks shown in FIG. 1 are provided as an example. In practice, there may be additional devices and/or networks, fewer devices, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

FIGS. 2A-2C depict simplified screen shots 200A-200C, respectively, of an exemplary user interface at which a user input may be received and a secured key may be returned to the user in response to the user input, according to one or more embodiments. The internal server system 114 may generate and/or provide one or more user interfaces which may be loaded onto one or more client devices that are authorized to communicate with the internal server system 114 (e.g., after ensuring that the client device has been authenticated, the requesting user has been authenticated, or a preconfigured setting authorized such a communication). For example, the internal server system 114 may authenticate a user into the exemplary user interface, by using single sign-on (SSO) authentication. In some implementations, one or more of admin devices 110 may communicate with the internal server system 114 over the network 108 (e.g., an intranet and/or a private network) and load the one or more user interfaces generated by the internal server system 114. Additionally, or alternatively, one or more of the user devices 112 may communicate with the internal server system 114 over the network 108 (e.g., an intranet and/or a private network) and load the one or more user interfaces generated by the internal server system 114.

The one or more user interfaces generated and provided by the internal server system 114 may include the exemplary user interface shown in FIGS. 2A-2C. For example, an admin device 110A may be used to troubleshoot issues experienced by user device 112A. When initiated by a system administrator on the admin device 110A, the admin device 110A may communicate with the internal server system 114 over the network 108 and load the exemplary user interface, as depicted in FIG. 2A, on a display device in communication with the admin device 110A. The exemplary user interface may include, for example, a text input field 210 and a clear icon 220. The text input field 210 may display one or more instructions at the admin device 110A (e.g., exemplary text “ENTER COMPUTER NAME OR EID”), that guide the user of the admin device 110A to enter an identifier associated with the user device 112A. The clear icon 220, when activated (e.g., clicked or touched), may clear any text input entered at the text input field 210, to allow a user to enter another text input into the text input field 210.

As shown in FIG. 2B, the exemplary user interface may receive an identifier 230 (e.g., exemplary text “ABC 123” as shown) at the text input field 210. In some implementations, the identifier 230 may be a computer name (a device identifier, a device-specific media access control (MAC) address, a nickname pre-assigned to a specific device, etc.) of the user device being managed, or an identifier associated with a user assigned to the device being managed (e.g., an employee identifier (EID), a personally identifiable information of the user, etc.). For example, a system administrator at the admin device 110A may input the exemplary text “ABC123,” which is the EID of a user of the user device 112A. In this example, the user device 112A may be the device being managed (e.g., receiving troubleshooting or having system updates installed thereto) by the admin device 110A. After entering the identifier 230, the user (e.g., system administrator) at the admin device 110A may trigger transmission of the identifier 230 by, for example, clicking on the search button (e.g., magnifying glass icon at the text input field 210 as shown in FIGS. 2A-2C), or pressing a key (e.g., ENTER key) that has been preconfigured to serve as the transmission trigger.

After the transmission of the identifier 230 has been triggered at the exemplary user interface, the device displaying the exemplary user interface (e.g., admin device 110A) may transmit the identifier 230, over the network 108, to an API endpoint at the internal server system 114. In some implementations, when the transmission of the identifier 230 is triggered, the internal server system 114 may use an API gateway included in the internal server system 114 to create a context stream, with an API endpoint of the internal server system 114 as the destination of the context stream. Under these implementations, the API gateway included in the internal server system 114 may be configured to accept a request that includes a path parameter. The path parameter may be the identifier 230 entered at the exemplary user interface. The API gateway may use this path parameter during the automated browsing process described in more detail below.

When the internal server system 114 receives the identifier 230, the internal server system 114 may create a headless browser that configures at least one processor (e.g., one or more processors at the internal server system 114) to automatically browse web pages (e.g., one or more pages of web site or web-based interfaces generated by the device management system 102) over the network 108 without loading any graphical user interface. Then, the internal server system 114 may use the headless browser to identify one or more credential data input fields (e.g., input fields configured to accept username and password of a system administrator account at the device management system 102) at a first set of one or more web pages (e.g., a log-in interface of the device management system 102).

In response to identifying the one or more credential data input fields, the internal server system 114 may identify a corresponding authentication credential for each of the one or more credential data input fields. For example, the internal server system 114 may be configured to retrieve a username and a password of a system administrator's account with the device management system 102, from a data repository at the internal server system 114, device management system 102, or one or more of the admin devices 110. Then, the internal server system 114 may then use the headless browser to automatically enter the identified corresponding authentication credential into each of the one or more credential data input fields in the first set of the one or more web pages. In this way, the headless browser may enter the authentication credentials into the web pages without loading any graphical user interface. For example, the process of logging into device management system 102 with a system administrator account may occur as a back-end process through such utilization of the headless browser, while the front-end interface at the admin device 110A may be displaying only the exemplary user interface shown in FIG. 2B.

The internal server system 114 may then determine a unique identifier of the user device being managed (e.g., one of the user devices 112), based on the identifier 230 received at an API endpoint of the internal server system 114. In some implementations, the unique identifier may be determined by simply equating the identifier 230 to the unique identifier. Additionally, or alternatively, the unique identifier may be determined by performing a query or a look-up operation based on the identifier 230 at a pre-stored mapping (e.g., a mapping residing in the internal server system 114 or one or more databases 106). For example, the unique identifier may be determined by adding the identifier 230 into a search query, transmitting the search query to a server system having a pre-stored mapping associated with unique identifiers, receiving a search result from the server system in response to the search query, and parsing the search result to identify the unique identifier.

Based on the determined unique identifier, the internal server system 114 may use the headless browser to enter a web interface associated with the unique identifier (e.g., a secured key retrieval section pertaining specifically to the unique identifier). For example, the device management system 102 may host a secure web interface specifically corresponding to the user device being managed. Such a web interface may be preconfigured for display as a web page or a tabbed section of a web page that may be located using the unique identifier. The internal server system 114 may use the headless browser to enter this web interface, and retrieve from the web interface a secured key corresponding to the unique identifier. For example, the internal server system 114 may use the headless browser to retrieve a web page having the secured key and parse the web page to identify the secured key. As another example, the internal server system 114 may use the headless driver to select a tab corresponding to the device matching the unique identifier, and call a function that retrieves the secured key (e.g., an action that may be equivalent to a human operator pressing a button in at a browser). The secured key may be, for example, a recovery key configured to recover data protected using a disk encryption program installed in an operating system of the user device being managed (e.g., user device 112A).

Referring now to FIG. 2C, the exemplary user interface may return the secured key 240. For example, a display device in communication with an admin device 110A may load the interface shown in FIG. 2C, in response to retrieving the correct recovery key for user device 112A that the system administrator needed for troubleshooting user device 112A. From the viewpoint of the system administrator, the interface shown in FIG. 2C may be the interface loaded immediately after transmitting the identifier 230 at the interface shown in FIG. 2B. Because of the automated process that uniquely engages the headless browser, the customized API gateway, the API endpoint, and the unique identifier determination process in the specific manner described in detail above with respect to FIG. 2B, the system administrator may be able to allow backend processing that automatically handles all of the authentication, communication, parsing, and processing tasks with device management system 102, whenever a secured key is needed for a specific user device. In this way, the automated process may enhance efficiency, accuracy, and security of the device management tasks such as retrieving recovery keys for user devices, while reducing or eliminating the need for the system administrators to depend on third party applications or third party APIs to perform such tasks.

FIGS. 2A-2C are provided to show an example interface. Other examples (e.g., differently arranged interfaces) are possible and may differ in arrangement, form, or design from what was described with regard to FIGS. 2A-2C.

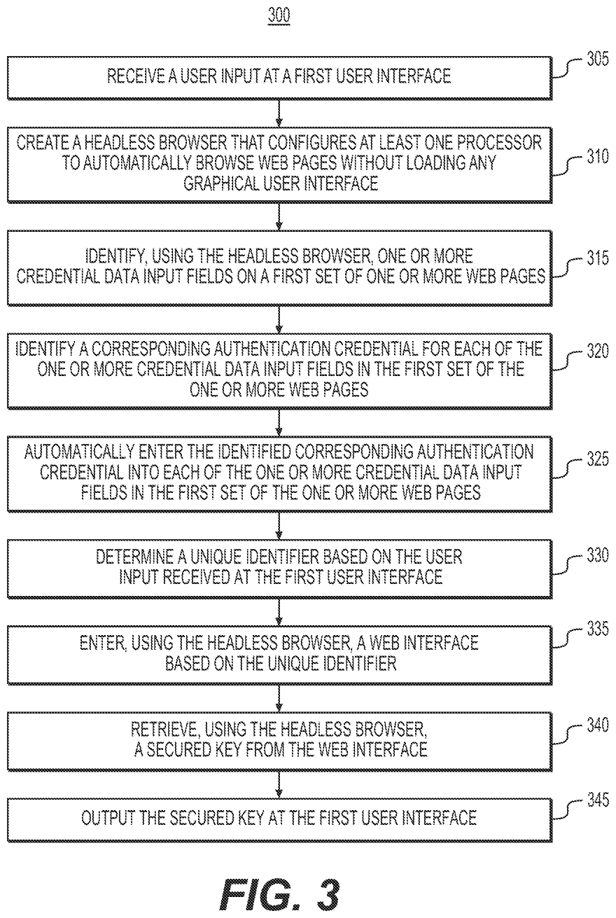

FIG. 3 depicts a flowchart of an exemplary method 300 for using automated browsing to retrieve a protected key based on a single input data entry, according to one or more embodiments. The internal server system 114 may first receive a user input at a first user interface (Step 305). The internal server system 114 may then create a headless browser that configures the at least one processor of the internal server system 114 to automatically browse web pages without loading any graphical user interface (Step 310). The internal server system 114 may also identify, using the headless browser, one or more credential data input fields on a first set of one or more web pages (Step 315). In response to the identified input fields, the internal server system 114 may identify a corresponding authentication credential for each of the one or more credential data input fields in the first set of the one or more web pages (Step 320). The internal server system 114 may automatically enter (e.g., using the headless browser) the identified corresponding authentication credential into each of the one or more credential data input fields in the first set of the one or more web pages (Step 325).

The internal server system 114 may then determine a unique identifier based on the user input received at the first user interface (Step 330). The unique identifier may correspond, for example, specifically to a user device, among the user devices 110. Based on the unique identifier, the internal server system 114 may enter a web interface, using the headless browser (Step 335). The web interface may be, for example, a secure web page or a section of a web page that contains data specific to the user device with the unique identifier. The internal server system 114 may then retrieve, using the headless browser, a secured key from the web interface (Step 340). The secured key may be, for example, a recovery key configured to recover data protected using a disk encryption program installed in an operating system of the user device being managed. After retrieving the secured key, the internal server system 114 may then output the secured key at the first user interface (Step 345). Accordingly, the user-front display at the first user interface may perform only the initial step 305 and the last step 345 of the exemplary method 300, while all of the intermediate steps may be performed as uniquely automated backend processing.

Although FIG. 3 shows example blocks of exemplary method 300, in some implementations, process 300 may include additional blocks, fewer blocks, different blocks, or differently arranged blocks than those depicted in FIG. 3. Additionally, or alternatively, two or more of the blocks of the exemplary method 300 may be performed in parallel.

If programmable logic is used, such logic may be executed on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor or a plurality of processors, or combinations thereof. Processor devices may have one or more processor “cores.”

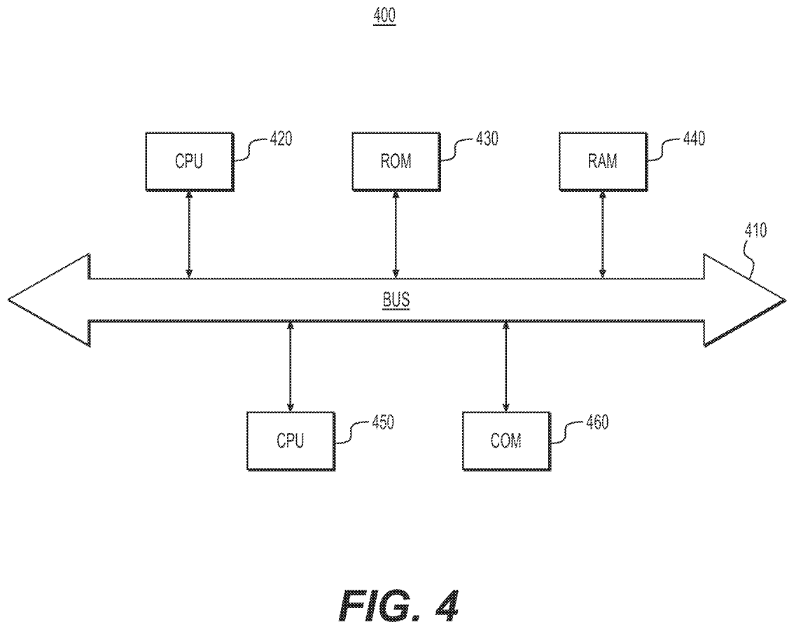

Various embodiments of the present disclosure, as described above in the examples of FIGS. 1, 2A-2C, and 3 may be implemented using device 400, as shown in FIG. 4. After reading this description, it will become apparent to a person skilled in the relevant art how to implement embodiments of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments, the order of operations may be rearranged without departing from the spirit of the disclosed subject matter.

As shown in FIG. 4, device 400 (e.g., device management system 102, admin devices 110, user devices 112, and/or internal server system 114) may include a central processing unit (CPU) 420. CPU 420 may be any type of processor device including, for example, any type of special purpose or a general-purpose microprocessor device. As will be appreciated by persons skilled in the relevant art, CPU 420 also may be a single processor in a multi-core/multiprocessor system, such system operating alone, or in a cluster of computing devices operating in a cluster or server farm. CPU 420 may be connected to a data communication infrastructure 410, for example, a bus, message queue, network, or multi-core message-passing scheme.

Device 400 also may include a main memory 440, for example, random access memory (RAM), and also may include a secondary memory 430. Secondary memory 430, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 430 may include other similar means for allowing computer programs or other instructions to be loaded into device 400. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 400.

Device 400 also may include a communications interface (“COM”) 460. Communications interface 460 allows software and data to be transferred between device 400 and external devices. Communications interface 460 may include a modem, a network interface (such as an Ethernet card), a communications port, a PCMCIA slot and card, or the like. Software and data transferred via communications interface 460 may be in the form of signals, which may be electronic, electromagnetic, optical, or other signals capable of being received by communications interface 460. These signals may be provided to communications interface 460 via a communications path of device 400, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 400 also may include input and output ports 450 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

It is intended that the specification and examples be considered as exemplary only, with a true scope and spirit of the disclosure being indicated by the following claims.

1. A computer system for using automated browsing to retrieve a protected key based on a single input data entry, the system comprising:
a memory device having processor-readable instructions stored therein; and
a central processing unit including at least one processor configured to access the memory device and execute the processor-readable instructions, which when executed by the processor configures the processor to perform a plurality of functions, including functions for:
receiving, at a device management system remote from an administrator device over a network, a user input provided at a first user interface, wherein the first user interface is rendered on the administrator device, wherein the administrator device is associated with a system administrator account, and wherein the user input includes an indicator of a user device associated with a user account;
creating, by the device management system remote from the administrator device, a headless browser that configures the at least one processor to automatically browse web pages without loading any graphical user interface;
identifying, using the headless browser, one or more credential data input fields on a first set of one or more web pages;
receiving, over the network from an internal server system, a corresponding authentication credential for each of the one or more credential data input fields in the first set of the one or more web pages, wherein the internal server system is remote from both the device management system and the administrator device;
automatically entering the corresponding authentication credential into each of the one or more credential data input fields in the first set of the one or more web pages;
determining a unique identifier, based on the user input received at the first user interface;
accessing, using the headless browser, a web interface based on the unique identifier;
retrieving, using the headless browser, a secured key from the web interface;
transmitting the secured key over the network to the administrator device; and
outputting the secured key at the first user interface.

2. The system of claim 1, wherein the function for determining the unique identifier further comprises:
adding the user input into a search query;
transmitting the search query to the internal server system;
in response to transmitting the search query, receiving a search result from the internal server system; and
parsing the search result to identify the unique identifier.

3. The system of claim 1, wherein the function for accessing the web interface based on the unique identifier further comprises:
accessing, using the headless browser, a secured key retrieval section within the web interface.

4. The system of claim 1, wherein the function for retrieving the secured key from the web interface further comprises:
parsing, using the headless browser, a web page included in the web interface to identify the secured key.

5. The system of claim 1, wherein the first user interface is in communication with an Application Programming Interface (API) gateway.

6. The system of claim 5, wherein the function for receiving the user input at the first user interface further comprises:
transmitting the user input to the API gateway.

7. The system of claim 1, wherein the function for receiving the user input at the first user interface further comprises:
authenticating. by the device management system remote from the administrator device, a first user into the first user interface prior to receiving the user input.

8. The system of claim 7, wherein the authenticating the first user into the first user interface comprises authenticating using single sign-on (SSO) authentication.

9. The system of claim 1, wherein the secured key is a recovery key configured to recover data protected using a disk encryption program installed in an operating system of the user device.

10. The system of claim 1, wherein the one or more credential data input fields include a username input field and a password input field.

11. A computer-implemented method for using automated browsing to retrieve a protected key based on a single input data entry, the method comprising:
receiving, by one or more processors, at a device management system remote from an administrator device over a network, a user input provided at a first user interface, wherein the first user interface is rendered on the administrator device, wherein the administrator device is associated with a system administrator account, and wherein the user input includes an indicator of a user device associated with a user account;
creating, by the one or more processors, at the device management system remote from the administrator device, a headless browser that configures the one or more processors to automatically browse web pages without loading any graphical user interface;
identifying, by the one or more processors, using the headless browser, one or more credential data input fields on a first set of one or more web pages;
receiving, by the one or more processors, over the network from an internal server system, a corresponding authentication credential for each of the one or more credential data input fields in the first set of the one or more web pages, wherein the internal server system is remote from both the device management system and the administrator device;
automatically entering, by the one or more processors, the corresponding authentication credential into each of the one or more credential data input fields in the first set of the one or more web pages;
determining, by the one or more processors, a unique identifier, based on the user input received at the first user interface;
accessing, by the one or more processors, using the headless browser, a web interface based on the unique identifier;
retrieving, by the one or more processors, using the headless browser, a secured key from the web interface;
transmitting, by the one or more processors, the secured key over the network to the administrator device; and
outputting, by the one or more processors, the secured key at the first user interface.

12. The method of claim 11, wherein the determining the unique identifier further comprises:
adding, by the one or more processors, the user input into a search query;
transmitting, by the one or more processors, the search query to the internal server system;
in response to transmitting the search query, receiving, by the one or more processors, a search result from the internal server system; and
parsing, by the one or more processors, the search result to identify the unique identifier.

13. The method of claim 11, wherein the accessing the web interface based on the unique identifier further comprises:
accessing, by the one or more processors, using the headless browser, a secured key retrieval section within the web interface.

14. The method of claim 11, wherein the retrieving the secured key from the web interface further comprises:
parsing, by the one or more processors, using the headless browser, a web page included in the web interface to identify the secured key.

15. The method of claim 11, wherein the first user interface is in communication with an Application Programming Interface (API) gateway.

16. The method of claim 15, wherein the receiving the user input at the first user interface further comprises:
transmitting, by the one or more processors, the user input to the API gateway.

17. The method of claim 11, wherein the receiving the user input at the first user interface further comprises:
authenticating, by the one or more processors, at the device management system remote from the administrator device, a first user into the first user interface prior to receiving the user input.

18. The method of claim 11, wherein the secured key is a recovery key configured to recover data protected using a disk encryption program installed in an operating system of the user device.

19. The method of claim 11, wherein the one or more credential data input fields include a username input field and a password input field.

20. A computer-implemented method for using automated browsing to retrieve a recovery key based on a single input data entry, the method comprising:
receiving, by one or more processors, at a device management system remote from an administrator device over a network, a user input provided at a first user interface, wherein the first interface is in communication with an Application Programming Interface (API) gateway, wherein the first user interface is rendered on an the administrator device, wherein the administrator device is associated with a system administrator account, and wherein the user input includes an indicator of a user device associated with a user account;
creating, by the one or more processors, at the device management system remote from the administrator device, a headless browser that configures the one or more processors to automatically browse web pages without loading any graphical user interface;
identifying, by the one or more processors, using the headless browser, one or more credential data input fields on a first set of one or more web pages;
receiving, by the one or more processors, over the network from an internal server system, a corresponding authentication credential for each of the one or more credential data input fields in the first set of the one or more web pages, wherein the internal server system is remote from both the device management system and the administrator device;
automatically entering, by the one or more processors, the corresponding authentication credential into each of the one or more credential data input fields in the first set of the one or more web pages;
accepting the user input at the API gateway;
determining, by the one or more processors, a unique identifier, based on the user input accepted at the API gateway;
accessing, by the one or more processors, using the headless browser, a web interface based on the unique identifier;
retrieving, by the one or more processors, using the headless browser, a recovery key from the web interface, wherein the recovery key is configured to recover data protected using a disk encryption program installed in an operating system of the user device;
transmitting, by the one or more processors, a secured key over the network to the administrator device; and
outputting, by the one or more processors, the recovery key at the first user interface.
